(19) United States
(12) Patent Application Publication
(10) Pub. No.: US 2011/0162583 A1
(43) Pub. Date: Jul. 7, 2011

(54) Disposable custom fit pet feeding bowl liner with mating engagement and release tip

(75) Inventors: Emil Rostamo, Northridge, CA (US); Johny Y. Mansour, Calabasas, CA (US); Ivan Ablakhat, Calabasas, CA (US)

(73) Assignee: Tigris Enterprises, LLC

(21) Appl. No.: 12/655,850

(22) Filed: Jan. 7, 2010

(51) Int. Cl. A01K 29/00

(52) U.S. Cl. 119/61.5

(57) ABSTRACT

A disposable custom fit pet feeding bowl liner which is removably placed over the food area of the feeding bowl so that food is placed into the liner and does not come in contact with the interior surface of the food bowl. When the animal has completed feeding and if there is any remaining unconsumed food in the food bowl or even if the food has been consumed and a dirty residue of food is left in the liner, the liner can be quickly and easily removed from the food dish and a new liner placed on the food dish so that new food can be placed onto the liner without having to clean and wash the food dish to clean away unconsumed food from the food bowl or dish.

### BACKGROUND OF THE INVENTION

1. Field of the Invention

The present invention relates to the field of feeding bowls into which pet food is placed for consumption by a pet. Most commonly, the feeding bowl is for use by pet dogs and cats, however the feeding bowl can be used to feed any animal, whether a domestic or a wild animal which is free to roam in nature and comes to a person's house or backyard for food.

2. Description of the Prior Art

Feeding bowls into which animal food placed are well known and come in all shapes and sizes. A common problem with food bowls, especially where the food placed therein is moist and/or in gravy is that the pet may not completely consume all of the food placed in the bowl and may leave a portion of the food in the bowl unconsumed. This is especially true for cats.

Therefore, the owner is left with the problem, of scooping out the unconsumed food and then throughly washing the food bowl before new food is placed into the bowl. This is a time consuming and messy process.

There is a significant need for an improved apparatus to eliminate the problem in disposing of unconsumed food from a food bowl and having to thoroughly wash the bowl before new food is placed in the bowl.

### SUMMARY OF THE INVENTION

The present invention is a disposable custom fit pet feeding bowl liner which is removably placed over the food area of the feeding bowl so that food is placed into the liner and does not come in contact with the interior surface of the food bowl. Therefore, when the animal has completed feeding and if there is any remaining unconsumed food in the food bowl or even if the food has been consumed and a dirty residue of food is left in the liner, the liner can be quickly and easily remove from the food dish and a new liner placed on the food dish so that new food can be placed onto the liner without having to clean and wash the food dish to clean away unconsumed food from the food bowl or dish.

An additional improvement in the present invention disposable liner is the inclusion of female receiving opening in the center of the food bowl and a male retaining pin on the underside of the disposable liner and aligned to be inserted into the female receiving opening when the liner is placed over the food bowl. The retaining pin assures that the liner will remain in place on the food bowl while the food is being consumed and in addition the retaining pin provides a quick release mechanism so that a pushing force on the retaining pin pushes the liner away from the food bowl and facilitates removal of the liner from the food bowl after the food has been consumed and the liner needs to be replaced.

The shape of the liner is matched to the shape of the food bowl so that it covers the interior food containing area and the upper circumferential area of the bowl which surrounds the interior food compartment so that the entire bowl remains clean and free of food.

It is therefore an object of the present invention to provide a disposable feeding bowl liner which is custom fit to match the shape of the food area and surrounding upper surface of the food bowl so that food will be retained on the liner and not come in contact with the food bowl. In this away, the liner is removed and replaced with a new liner without the requirement to scrape unconsumed food from the food bowl and without the requirement to wash the food bowl before fresh food is placed onto the liner.

It is further object of the present invention to proving a mating retaining means on the liner and the food bowl so that the retaining means will assure that the liner remains on the food bowl while an animal is consuming the food even if the animal exerts a vigorous force on the liner while the animal is feeding, and further provides a release means by which the liner can be released from the food bowl so that it can be disposed of and replaced with a new liner.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is an exploded view of a food bowl and the present invention disposable custom fit liner with mating engagement and release tip;

FIG. 2 is an exploded cross-sectional view of a food bowl and the present invention disposable custom fit liner with mating engagement and release tip; and

FIG. 3 is a top plan view of the present invention disposable custom fit liner with mating engagement and release tip and the pet food bowl.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

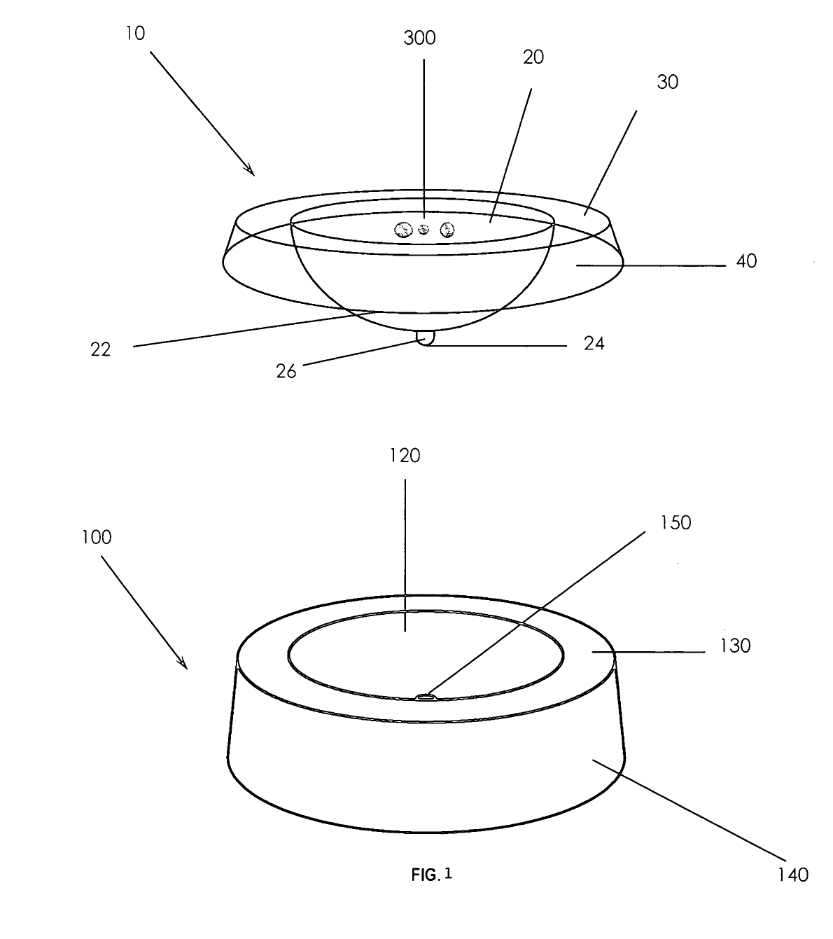

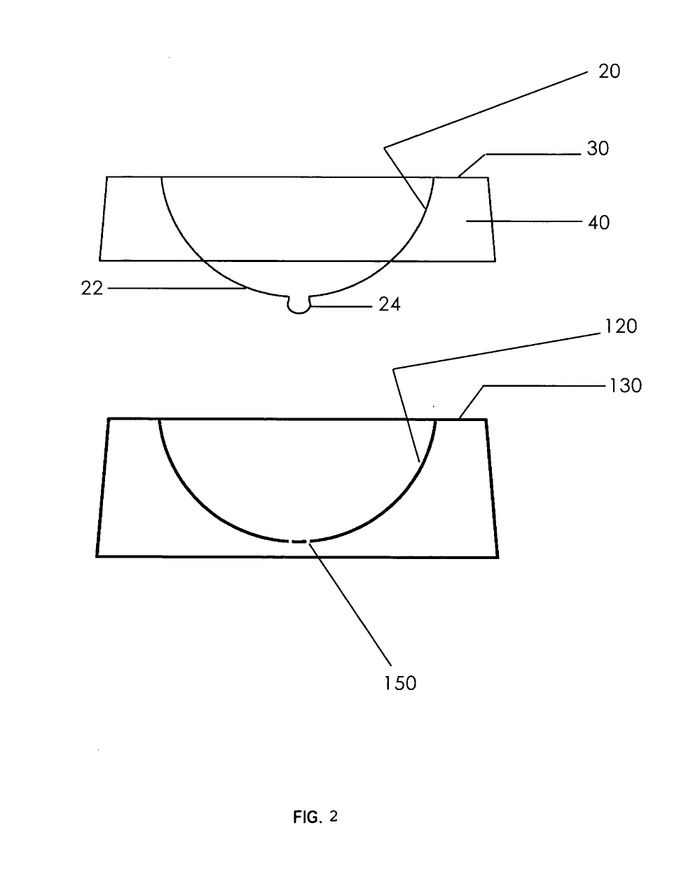

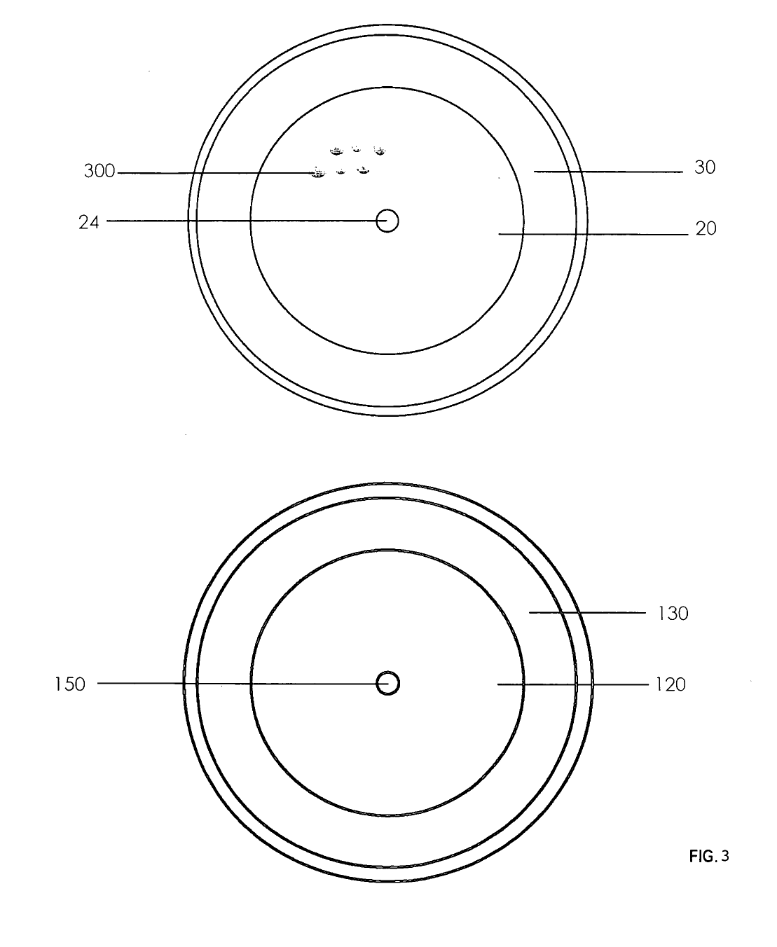

Referring to FIGS. 1 through 3 there is illustrated the components of the present invention. The present invention is used with a pet food bowl 100 which has an interior food receiving section 120 surrounded by an exterior circumferential lip 130 which extends to the body 140 which is placed on a surface such as the floor or a mat. The pet food bowl 100 including interior food receiving area 120, circumferential lip 130 and body 140 have a given shape. In the illustration, the bowl is round. It will be appreciated that any shape food bowl 100, whether round, square, oval or any other shape is within the spirit and scope of the present invention.

One improvement incorporated into the food bowl 100 is a central opening 150 located at the center of the food receiving section 120 and extending through the entire thickness of the food bowl at this location.

The present invention disposable liner 10 is a unitary body comprised of interior food receiving area 20, circumferential lip 30 and body 40 having a given shape which matches the shape of the corresponding components of the food bowl 100. In the illustration, since the bowl is round with a sidewall that is at a slight outwardly extending angle, the disposable liner is also round and also has a matching sidewall extending at the same outwardly extending angle as the food bowl. At the bottom surface 22 of the interior food receiving section is a mating engagement member or pin 24 which extends perpendicularly to the surface 22. When the disposable liner 10 is placed over the food bowl 100, the engagement pin 24 is inserted into central opening 150. The shape the disposable liner 10 matches the shape of food bowl 100, so that the shape of the food receiving section 20 of the disposable liner 10 matches the shape of the food receiving section 120 of the food bowl 100, the shape of the circumferential lip 30 of the disposable liner 10 matches the shape of the circumferential lip 130 of the food bowl 100, and shape of the body 40 of the disposable liner matches the shape of the body 140 of the food bowl 100. The engagement pin 24 is inserted into opening 150 which assures that the liner 10 will remain in place. The opening 150 and engagement pin 24 are sized to assure a press fit the of engagement pin 24 into the opening 150 if the food bowl 100. It will be appreciated that any shape liner 10, whether round, square, oval or any other shape is within the spirit and scope of the present invention so that it matches the shape of the food bowl.

Food 300 is placed on the food area section 20 of the disposable liner 10. When the food is consumed or even if there is left over food and the liner 10 needs to be replaced, a pushing force against the engagement pin 24 serves to release it from its press fit engagement into the opening 150 and the used disposable liner 10 can thereby be removed and discarded and a new disposable liner 10 placed over the food bowl 100 and retained as discussed above, all without the necessity of having to clean any portion of the food bowl 100.

The disposable liner 10 and all of its components can be made of clear or opaque material and can be made of material selected from the group consisting of plastic, polyvinyl, polyvinyl chloride, rubber or any other thin and flexible material. The engagement pin 24 can have a strengthening member 26 inserted into it to give it more strength or simply can be formed of hard plastic or comparable material.

Defined in detail, the present invention is a liner used with a food bowl having a center food retaining section, a circumferential lip surrounding the food retaining section and a sidewall body descending from the circumferential lip, the food retaining section, circumferential lip and sidewall body having a given shape, and liner comprising: (a) a liner body having a center food retaining section, a liner circumferential lip surrounding the liner food retaining section, and a liner sidewall body descending from the liner circumferential lip, the shape of the liner center food retaining section matching the shape of the food bowl center food retaining section, the shape of the liner circumferential lip matching the shape of the food bowl circumferential lip, and the shape of the liner sidewall body matching the shape of the sidewall body of the food bowl; (b) the center food retaining section of the food bowl having a transverse opening extending through it from an interior surface of the center food retaining section to an exterior surface of the food retaining section; and (c) a transverse engagement pin extending perpendicularly from an exterior surface of the liner center food retaining section and inserted into the transverse opening in the center food retaining section of the food bowl and retained therein by a press fit, the liner fitting over the food bowl so that the center food retaining section, circumferential lip and sidewall body of the food bowl are respectively covered by the liner center food retaining section, liner circumferential lip and liner sidewall body.

Defined broadly, the present invention is a liner used with a food bowl having a center food retaining section, a circumferential lip surrounding the food retaining section and a sidewall body descending from the circumferential lip, the food retaining section, circumferential lip and sidewall body having a given shape, and liner comprising: (a) a liner body having a center food retaining section, a liner circumferential lip surrounding the liner food retaining section, and a liner sidewall body descending from the liner circumferential lip, the shape of the liner center food retaining section matching the shape of the food bowl center food retaining section, the shape of the liner circumferential lip matching the shape of the food bowl circumferential lip, and the shape of the liner sidewall body matching the shape of the sidewall body of the food bowl; (b) the liner fitting over the food bowl so that the center food retaining section, circumferential lip and sidewall body of the food bowl are respectively covered by the liner center food retaining section, liner circumferential lip and liner sidewall body.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

What is claimed is:

1. A liner used with a food bowl having a center food retaining section, a circumferential lip surrounding the food retaining section and a sidewall body descending from the circumferential lip, the food retaining section, circumferential lip and sidewall body having a given shape, and liner comprising:
a. a liner body having a center food retaining section, a liner circumferential lip surrounding the liner food retaining section, and a liner sidewall body descending from the liner circumferential lip, the shape of the liner center food retaining section matching the shape of the food bowl center food retaining section, the shape of the liner circumferential lip matching the shape of the food bowl circumferential lip, and the shape of the liner sidewall body matching the shape of the sidewall body of the food bowl;
b. the center food retaining section of the food bowl having a transverse opening extending through it from an interior surface of the center food retaining section to an exterior surface of the food retaining section; and
c. a transverse engagement pin extending perpendicularly from an exterior surface of the liner center food retaining section and inserted into the transverse opening in the center food retaining section of the food bowl and retained therein by a press fit, the liner fitting over the food bowl so that the center food retaining section, circumferential lip and sidewall body of the food bowl are respectively covered by the liner center food retaining section, liner circumferential lip and liner sidewall body.

2. The liner in accordance with claim 1 wherein the liner is made of material selected from the group consisting of plastic, polyvinyl, polyvinyl chloride and rubber.

3. The liner in accordance with claim 1 wherein the shape of the liner is selected from the group consisting of round, square, and oval.

4. The liner in accordance with claim 1 wherein the liner is made of transparent material.

5. The liner in accordance with claim 1 wherein the liner is made of opaque material.

6. The liner in accordance with claim 1 wherein the engagement pin is made of hard plastic.

7. The liner in accordance with claim 1 wherein the engagement pin has a hard insert within the engagement pin.

8. The liner in accordance with claim 1 wherein the liner is disposable.

9. A liner used with a food bowl having a center food retaining section, a circumferential lip surrounding the food retaining section and a sidewall body descending from the circumferential lip, the food retaining section, circumferential lip and sidewall body having a given shape, and liner comprising:
a. a liner body having a center food retaining section, a liner circumferential lip surrounding the liner food retaining section, and a liner sidewall body descending from the liner circumferential lip, the shape of the liner center food retaining section matching the shape of the food bowl center food retaining section, the shape of the liner circumferential lip matching the shape of the food bowl circumferential lip, and the shape of the liner sidewall body matching the shape of the sidewall body of the food bowl;
b. the liner fitting over the food bowl so that the center food retaining section, circumferential lip and sidewall body of the food bowl are respectively covered by the liner center food retaining section, liner circumferential lip and liner sidewall body.

10. The liner in accordance with claim 9 wherein the liner is made of material selected from the group consisting of polyethylene plastic, polyvinyl, polyvinyl chloride and rubber.

11. The liner in accordance with claim 9 wherein the shape of the liner is selected from the group consisting of round, square, and oval.

12. The liner in accordance with claim 9 wherein the liner is made of transparent material.

13. The liner in accordance with claim 9 wherein the liner is made of opaque material.

14. The liner in accordance with claim 9 wherein the liner is disposable.
